(19) United States
(12) Patent Application Publication
(10) Pub. No.: US 2017/0042362 A1
(43) Pub. Date: Feb. 16, 2017

(54) BEVERAGE BREWING PACKAGE

(71) Applicant: Berry Plastics Corporation, Evansville, IN (US)

(72) Inventors: Zachary M Bunner, Richland, IN (US); Ryan Dewig, Evansville, IN (US); David C Arnold, Evansville, IN (US); Jared B Waterman, Evansville, IN (US); David W Conant, Sanford, NC (US)

(21) Appl. No.: 15/236,010

(22) Filed: Aug. 12, 2016

Related U.S. Application Data
(60) Provisional application No. 62/355,366, filed on Jun. 28, 2016.
(60) Provisional application No. 62/205,314, filed on Aug. 14, 2015.

(51) Int. Cl. A47J 31/06; B65D 85/804; B65D 21/02; A47J 31/36

(52) U.S. Cl. CPC A47J 31/0626; A47J 31/36; B65D 85/8043; B65D 21/0213

(57) ABSTRACT

A beverage brewing package includes a cup and a filter bag. The filter bag is supported in an interior region formed in the cup.

### PRIORITY CLAIM

This application claims priority under 35 U.S.C. §119(e) to U.S. Provisional Application Ser. No. 62/355,366, filed Jun. 28, 2016 and U.S. Provisional Application Ser. No. 62/205,314, filed Aug. 14, 2015, each of which is expressly incorporated by reference herein.

### BACKGROUND

The present disclosure relates to a package, and particularly to one-cup beverage brewing systems. More particularly, the present disclosure relates to a cup made of plastics material and included in a one-cup beverage package

### SUMMARY

A beverage brewing package in accordance with the present disclosure includes a cup having a bowl formed to include an interior region. In illustrative embodiments, the brewing package also includes coffee, tea, or cocoa grinds stored in an interior region of the bowl.

In illustrative embodiments, the bowl comprises polypropylene and is made using a thermoforming process. The bowl includes a floor and a side wall extending upwardly from the floor. The side wall includes a series of side-wall stiffeners extending between the side wall and the floor that configured to maximize stiffness of the side wall. The bowl also includes a stacking shoulder coupled to the upper portion of the side wall and a brim coupled to an upper portion of the stacking shoulder.

In illustrative embodiments, the floor includes a floor mount, a floor disc, and a floor stiffener. The floor mount is coupled to the side wall and the series of side-wall stiffeners. The floor disc is spaced-apart radially from the floor mount and the side wall. The floor stiffener is arranged to extend between and interconnect the floor mount and the floor disc and configured to minimize deformation of the floor disc during puncture of cup by the outlet cannula prior to brewing.

Additional features of the present disclosure will become apparent to those skilled in the art upon consideration of illustrative embodiments exemplifying the best mode of carrying out the disclosure as presently perceived.

### BRIEF DESCRIPTIONS OF THE DRAWINGS

The detailed description particularly refers to the accompanying figures in which:

FIG. 1 is a perspective view of a first embodiment of a beverage brewing package in accordance with the present disclosure showing that the beverage brewing package includes a cup that has been made using, for example, a thermoforming process;

FIG. 2 is a sectional view taken along lines 2-2 of FIG. 1 showing that the beverage brewing package includes a cup and a grinds carrier including a bag-supporting panel coupled to a brim of the cup and a filter bag containing grinds and mating with the underside of the bag-supporting panel to suspend the filter bag above a floor of the cup;

FIG. 3 is a perspective view of the cup of FIGS. 1 and 2 showing that the cup includes, from top to bottom, a brim and a bowl including a side wall, a floor, a plurality of side-wall stiffeners coupled to the floor and the side wall to maximize strength of the bowl;

FIG. 4 is a diagrammatic view of a one-cup beverage brewing system such as a coffee maker showing that the cup is supported on a cup support and pressurized hot water is admitted into the filter bag through an inlet cannula arranged to pierce a portion of the bag-supporting panel located over the bowl and brewed coffee is discharged from the cup through an outlet cannula arranged to pierce a portion of the floor;

FIG. 5 is a sectional view taken along line 5-5 of FIG. 2 showing that a side wall of the bowl includes the side-wall stiffeners positioned around a circumference of the bowl and that each side-wall stiffener has a generally triangular shape when viewed from above looking down;

FIG. 6 is an enlarged portion of the side wall taken from the circled region shown in FIG. 5 showing that the side-wall stiffeners each include a pair of converging stiffener panels which extend radially inward from a frustoconical panel of the side wall and engage with the floor of the bowl;

FIG. 7 is a first sectional view taken along line 7-7 of FIG. 3 between pairs of neighboring side-wall stiffeners;

FIG. 8 is an enlarged portion of the floor and side wall taken from the circled region shown in FIG. 7 showing that the floor includes a floor mount coupled to the side wall, a floor stiffener coupled to floor mount, and a floor disk coupled to the floor stiffener and configured to engage with the outlet cannula of the brewing system;

FIG. 9 is a second sectional view taken along line 9-9 of FIG. 3 through opposite side-wall stiffeners;

FIG. 10 is an enlarged portion of the floor and side wall taken from the circled region of FIG. 9 showing that each stiffener panel is defined by a base leg extending along the floor mount of the floor, a support leg extending along the frustoconical panel from the base leg, and a tie leg extending between the distal ends of the base leg and support leg;

FIG. 11 is an upper perspective view of the bowl of the cup of FIG. 1;

FIG. 12 is a lower perspective view of the bowl of the cup of FIG. 1;

FIG. 13 is an enlarged portion of the bowl taken from the circled region shown in FIG. 12;

FIG. 14 is a view similar to FIG. 2 showing a stack of two cups with one cup nested inside the other;

FIG. 15 is an enlarged portion of the stack of cups taken from the circled region shown in FIG. 14 and showing that a stacking shoulder of a top cup engages a shoulder-support rim of an underlying cup to maintain a minimum separation distance D_{S} between the stacked top and bottom cups;

FIG. 16 is a perspective view of a beverage brewing package including a cup that has been made in accordance with the present disclosure using, for example, a thermoforming process;

FIG. 17 is a sectional view taken along lines 17-17 of FIG. 16 showing that the beverage brewing package includes a cup and a grinds carrier including a bag-supporting panel coupled to a brim of the cup and a filter bag containing grinds and mating with the underside of the bag-supporting panel to suspend the filter bag above a floor of the cup;

FIG. 18 is a perspective view of the cup of FIGS. 16 and 17 showing that the cup includes, from top to bottom, a brim and a bowl including a side wall, a floor, a plurality of side-wall stiffeners coupled to the floor and the side wall to maximize strength of the bowl;

FIG. 19 is a diagrammatic view of a one-cup beverage brewing system such as a coffee maker showing that the cup is supported on a cup support and pressurized hot water is admitted into the filter bag through an inlet cannula arranged to pierce a portion of the bag-supporting panel located over the bowl and brewed coffee is discharged from the cup through an outlet cannula arranged to pierce a portion of the bag-supporting panel located over the spout;

FIG. 20 is a sectional view taken along line 20-20 of FIG. 17 showing that a side wall of the bowl includes the side-wall stiffeners positioned around a circumference of the bowl and that each side-stiffener has a generally triangular shape when viewed from above looking down;

FIG. 21 is an enlarged portion of the side wall taken from the circled region shown in FIG. 20 showing that the side-wall stiffeners each include a pair of converging stiffener panels which extend radially inward from a frustoconical panel of the side wall and engage with the floor of the bowl;

FIG. 22 is an enlarged portion of the side wall taken from the boxed region of FIG. 17 showing that the each stiffener panel is defined by a base leg extending along the floor, a support leg extending along the frustoconical panel from the base leg, and a tie leg extending between the distal ends of the base leg and support leg;

FIG. 23 is an upper perspective view of the bowl of the cup of FIG. 16;

FIG. 24 is a lower perspective view of the bowl of the cup of FIG. 16;

FIG. 25 is an enlarged portion of the bowl taken from the circled region shown in FIG. 24;

FIG. 26 is a view similar to FIG. 17 showing a stack of two cups with one cup nested inside the other;

FIG. 27 is an enlarged portion of the stack of cups taken from the circled region shown in FIG. 26 and showing that a stacking shoulder of a top cup engages a shoulder-support rim of an underlying cup to maintain a minimum separation distance Dₛ between the stacked top and bottom cups;

FIG. 28 is a perspective view of the cup of FIG. 16;

FIG. 29 is a front view of the cup of FIG. 28;

FIG. 30 is a rear view of the cup of FIG. 28;

FIG. 31 is a right side view of the cup of FIG. 28;

FIG. 32 is a left side view of the cup of FIG. 28;

FIG. 33 is a top plan view of the cup of FIG. 28; and

FIG. 34 is a bottom view of the cup of FIG. 28.

### DETAILED DESCRIPTION

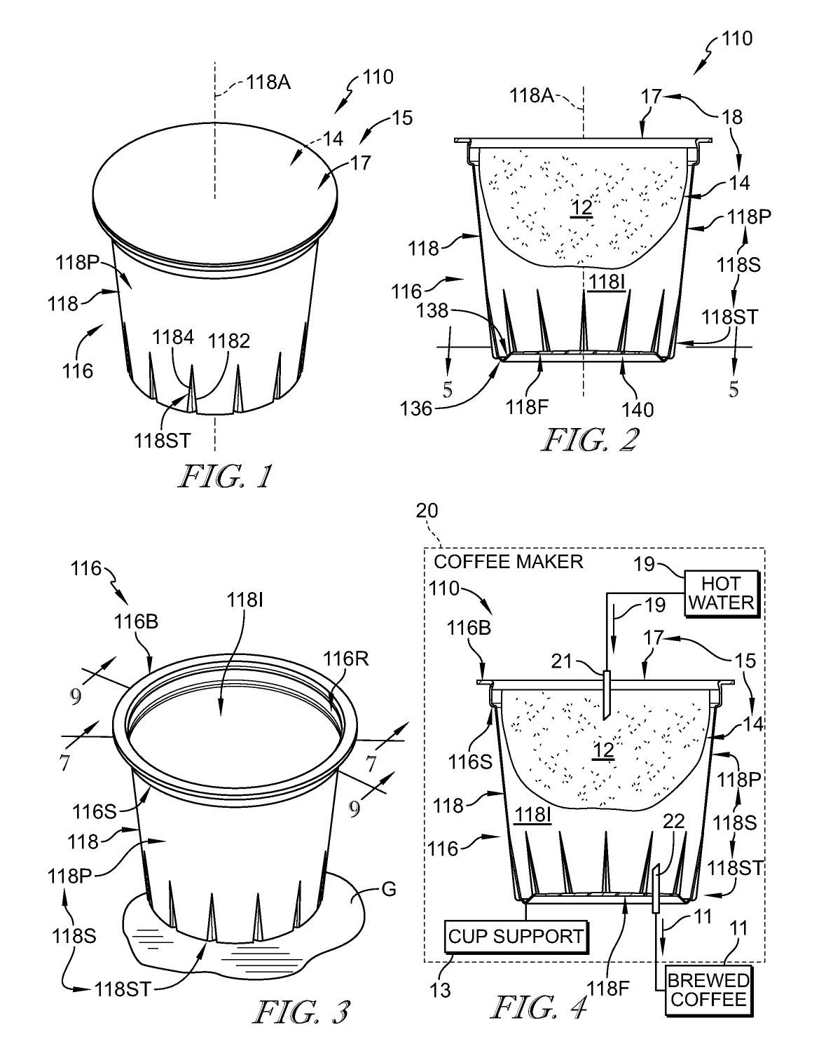

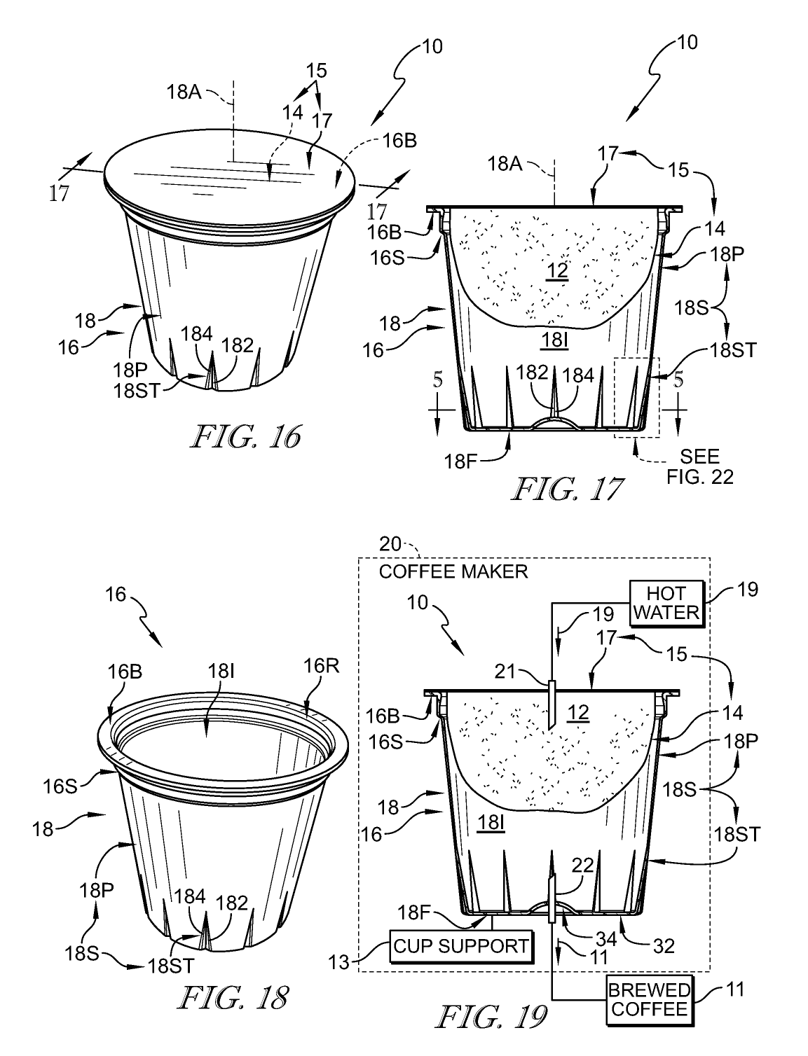

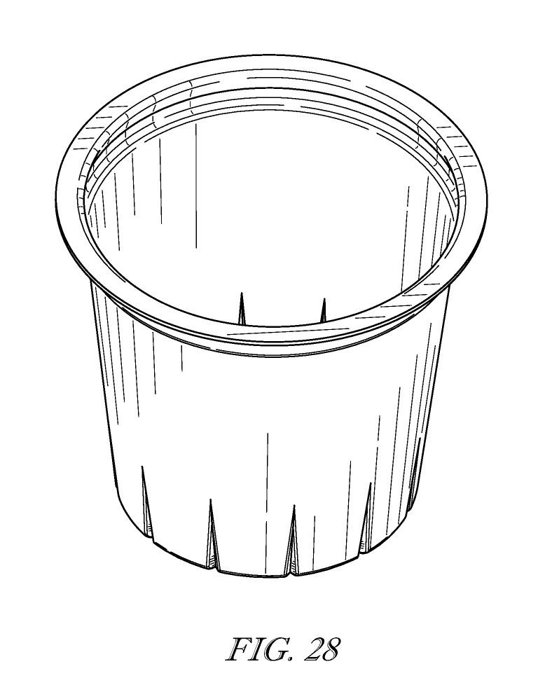

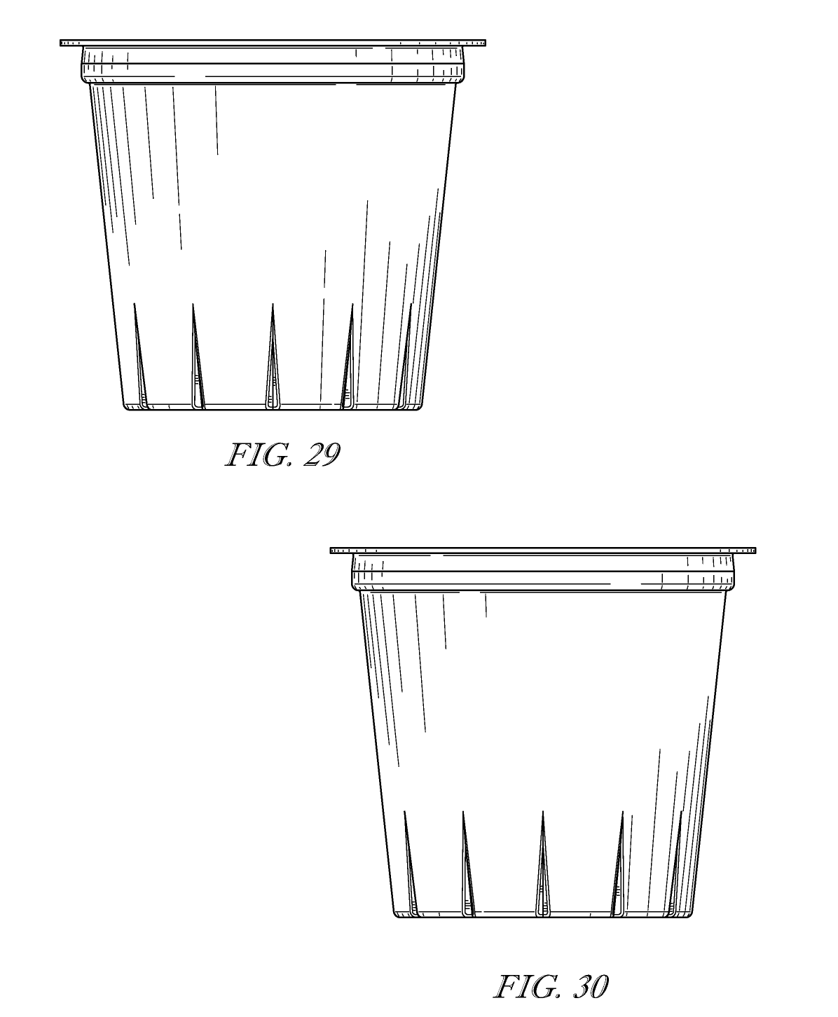

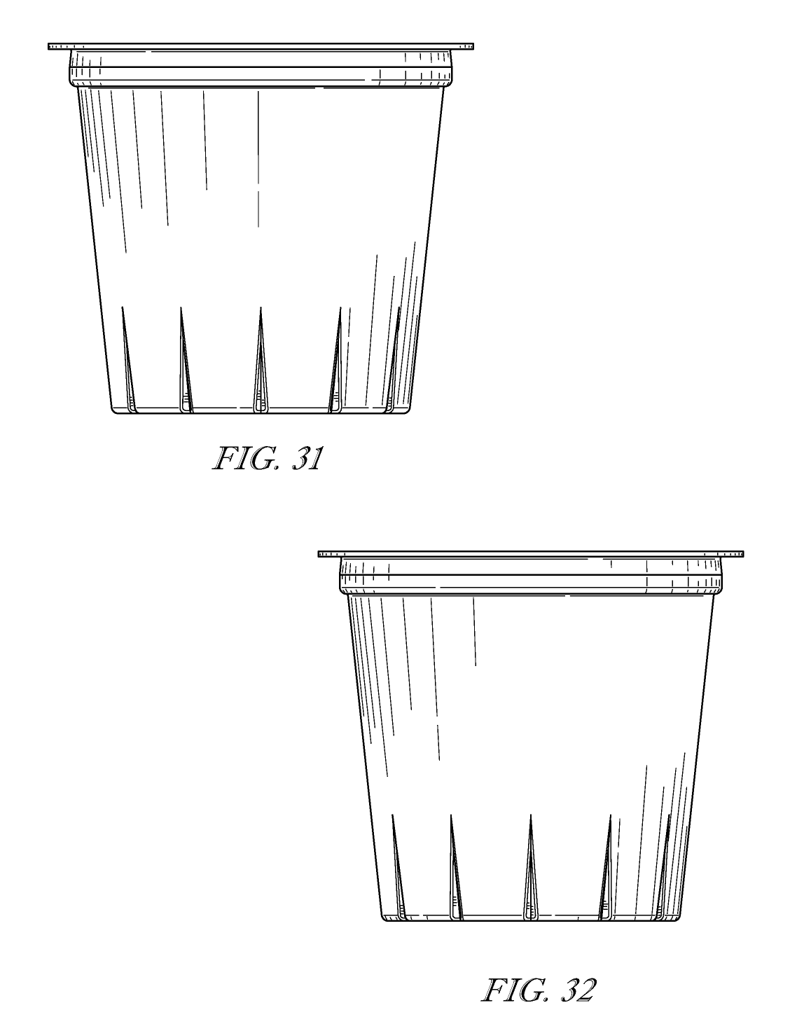

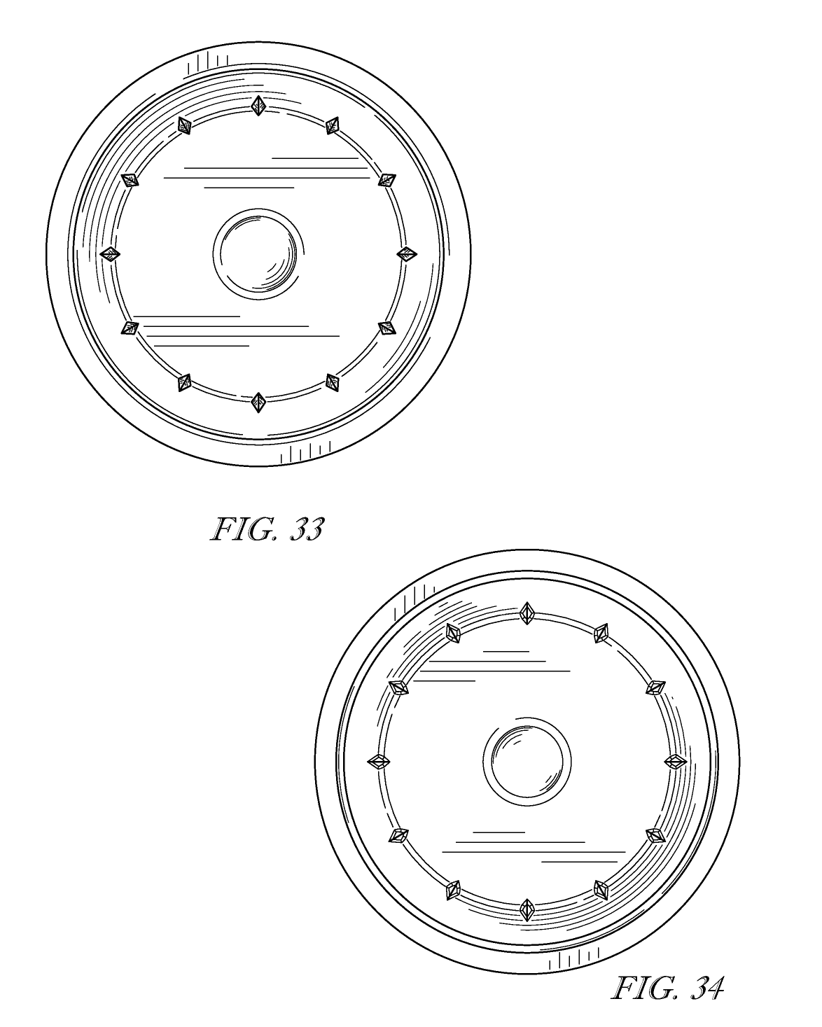

A first embodiment of a beverage brewing package 110 in accordance with the present disclosure is shown in FIGS. 1-15. A second embodiment of a beverage brewing package 10 in accordance with the present disclosure is shown in FIGS. 16-34. Beverage brewing package 110 and 10 is configured to resist deformation of the side wall and the floor so that a cup 116, 16 included in the beverage brewing package maintains its shape when handled by a user, during assembly of the beverage brewing package, during puncture of the brewing package by cannula prior to brewing, and during exposure of the brewing package to hot, high pressure water during brewing.

Beverage brewing package 110 in accordance with the present disclosure is shown in FIG. 1. Beverage brewing package 110 is configured to store coffee grinds 12 in a filter bag 14 retained in a cup 116 as suggested in FIG. 2. A consumer may brew coffee 11, or any other suitable beverage, by placing beverage brewing package 110 in a beverage maker 20, also called coffee maker 120, and exposing coffee grinds 12 stored in filter bag 14 to pressurized hot water discharged from hot water source 19 as suggested in FIG. 4. Beverage brewing package 110 may also be used to brew tea by storing tea grinds in filter bag 14.

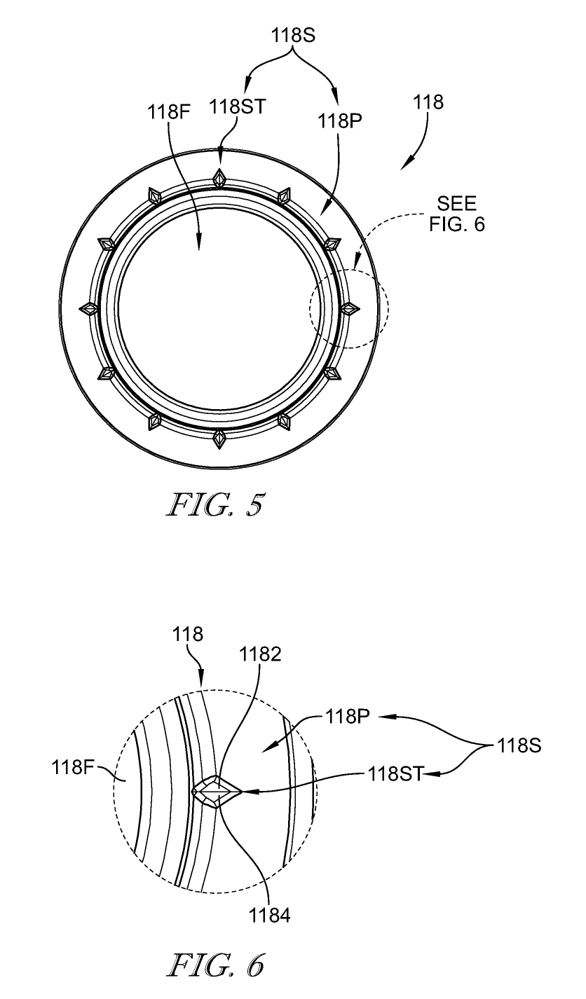

Cup 116 includes a bowl 118 having a floor 118F and a side wall 118S extending from floor 118F as shown, for example, in FIGS. 5-15. Side wall 118S includes a frustoconical panel 118P extending from floor 118F to define an interior region 1181 of bowl 118 and a series of side-wall stiffeners 1185T extending into interior region 1181. Side-wall stiffeners 1185T are coupled between floor 118F and frustoconical panel 118P to provide additional stiffness to side wall 118S than that provided by frustoconical panel 18P alone.

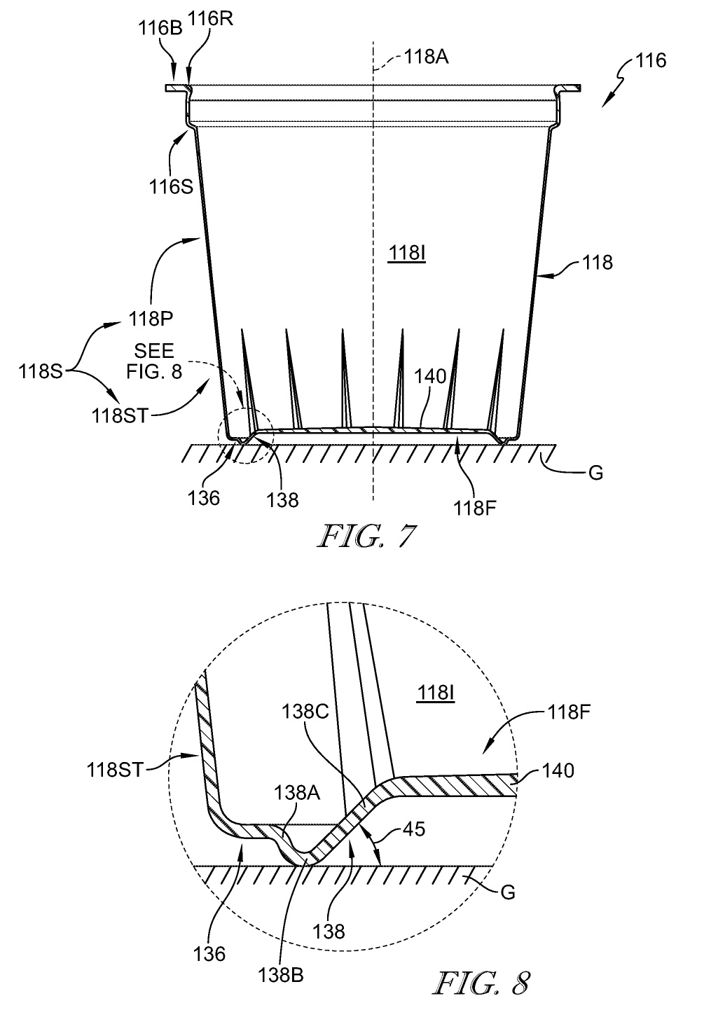

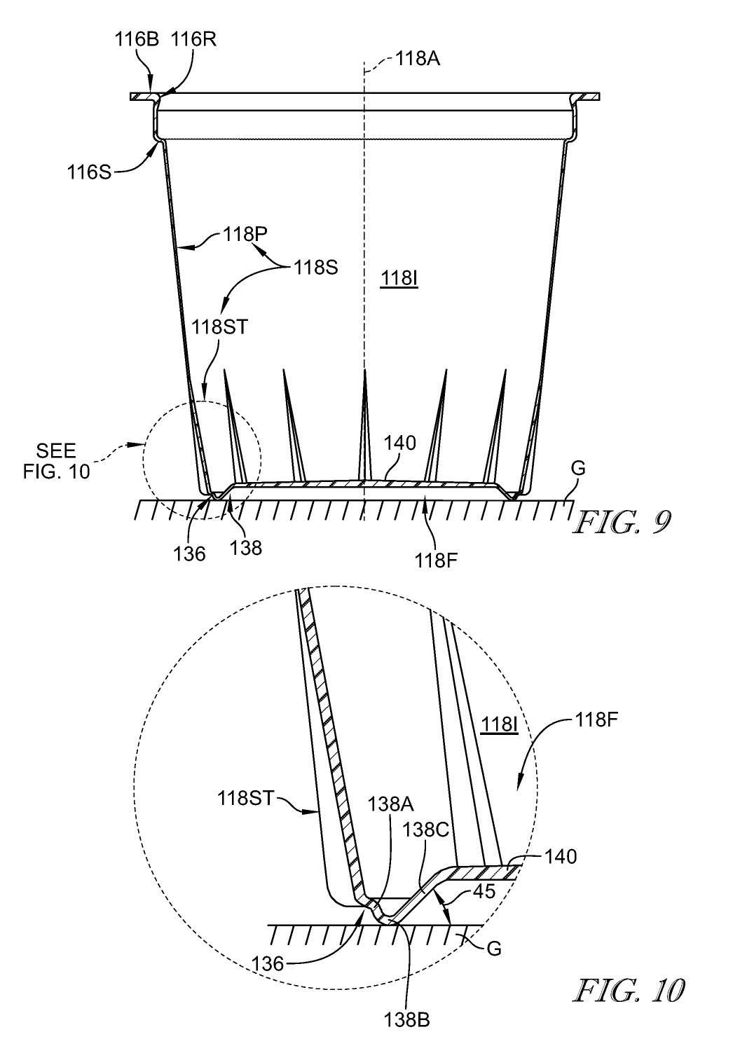

Floor 118F includes a floor mount 136, a floor stiffener 138, and a floor disk 140 as shown in FIGS. 7-10. Floor mount 136 is coupled to frustoconical panel 118P and side-wall stiffeners 118ST to extend inwardly toward a central axis 118A as shown in FIGS. 8 and 10. Central axis 118A extends through and is about perpendicular to floor disk 140. Floor disk 140 is arranged to extend outwardly from central axis 118A toward floor mount 136. Floor stiffener 138 is arranged to extend between and interconnect floor mount 136 and floor disk 140 as shown in FIG. 8. Floor stiffener 138 is configured to minimize deformation of floor 118F during puncture of beverage brewing package 110 by the outlet cannula 22 prior to brewing.

Cup 116 also includes a stacking shoulder 116S coupled to an upper portion of side wall 118S of bowl 118 and a brim 116B coupled to an upper region of stacking shoulder 116S as shown, for example, in FIGS. 1-3. Brim 16B is configured to provide an uninterrupted border surrounding a top opening into interior region 181 and defines a shoulder-support rim 16R. Stacking shoulder 16S cooperates with shoulder-support rim 16R′ included in a neighboring cup 16′ in a stack 100 of cups 16, 16′ to maintain a minimum separation distance D_{S} between stacked cups 16, 16′ so that cups included in a stack 100 of cups that has been shipped to a brewing package assembly factory can be separated easily at that factory to facilitate manufacture and assembly of beverage brewing package 10.

Cup 116 and its bowl 118 are made using a thermoforming process in accordance with the illustrative embodiments of the present disclosure to facilitate positive formation of side-wall stiffeners 118ST, floor stiffener 138, stacking shoulder 1116S, and brim 1118B, for example. Cup 116 is formed from a thermoplastic material, such as polypropylene for example. In one example, the polypropylene is a polypropylene homopolymer. In another example, the polypropylene is a high crystalline polypropylene homopolymer. In another example, the polypropylene is INSPIRE 6025N available from BRASKEM.

Polypropylene may have a relatively lower rigidity. In the illustrative embodiment, portions of frustoconical panel 118P of bowl 118 are also thinner than the other components of cup 116, as suggested in FIGS. 7-10. The thinner material has less rigidity than the other portions of cup 116 and side-wall stiffeners 118ST and floor stiffener 138 are configured to stiffen side wall 118S against radially inward forces acting on cup 116 during exposure of cup 116 to hot pressurized water during brewing and against vertically acting compressive forces acting on cup 116 during puncture of cup 116 by cannula 21, 22 prior to brewing.

Beverage brewing package 110 includes a grinds carrier 15 comprising a bag-supporting panel 17 coupled to brim 116B of cup 116 and filter bag 14 as shown in FIGS. 2 and 4. Filter bag 14 mates with the underside of bag-supporting panel 17 to support filter bag 14 above floor 118F of bowl 118. Bag-supporting panel 17 is made of a metallic foil or a plastics film in illustrative embodiments of the present disclosure. Filter bag 14 is made of a water-permeable filter material and is configured to hold coffee, tea, or similar brewable particulates.

A diagrammatic view of a beverage brewing system such as a coffee maker 20 is provided in FIG. 4. Cup 116 of beverage brewing package 110 is placed on a cup support 13 included in coffee maker 20. Pressurized hot water 19 is admitted into filter bag 14 through an inlet cannula 21 that is arranged to pierce a portion of bag-supporting panel 17 located over bowl 18. Brewed coffee 11 is discharged from cup 16 through an outlet cannula 22 arranged to pierce floor disk 140 of floor 118F located below filter bag 14. Brewed coffee 11 is produced by exposing pressurized hot water 19 to coffee grinds 12 carried in filter bag 14. Such brewed coffee 11 flows into interior region 1181 of bowl 118 and then exits beverage brewing package 110 through outlet cannula 22 as suggested in FIG. 4.

Side wall 118S of bowl 118 has a frustoconical shape as suggested in FIGS. 2 and 3 with a narrow end alongside floor 118F and a relatively wider end alongside brim 116B. Side wall 118S is to extend upwardly from a perimeter edge of floor mount 136 toward stacking shoulder 116S and brim 116B. Side wall 118S cooperates with floor 118F to form interior region 1181 of bowl 118 as suggested in FIG. 3.

Side wall 118S includes a generally frustoconical panel 118P extending from floor 118F to stacking shoulder 116S and a series of circumferentially spaced, radially inwardly extending side-wall stiffeners 1185T as shown in FIGS. 5-13. Side-wall stiffeners 1185T are configured to resist radially inward forces placed on side wall 118S by a user handling beverage brewing package 110 or during assembly of beverage brewing package 110. In some instances, side-wall stiffeners 1185T are configured to resist radially inward buckling due to force placed on the top and/or bottom during brewing. In some embodiments, more or less side-wall stiffeners 1185T are used to increase or decrease the stiffness of side wall 118S, respectively.

Each side-wall stiffener 1185T includes a pair of converging stiffener panels 1182, 1184 coupled between floor 118F and frustoconical panel 118P. Each stiffener panel 1182, 1184 is defined by a base leg 1181 extending along floor 118F, a support leg 1183 extending upward from floor 118F along frustoconical panel 118P, and a tie leg 1185 extending between distal ends of base leg 1181 and support leg 1183. Each stiffener panel 1182, 1184 is substantially triangular in shape and the tie legs 1185 of adjacent stiffener panels 1182, 1184 are coupled to one another as suggested in FIG. 12.

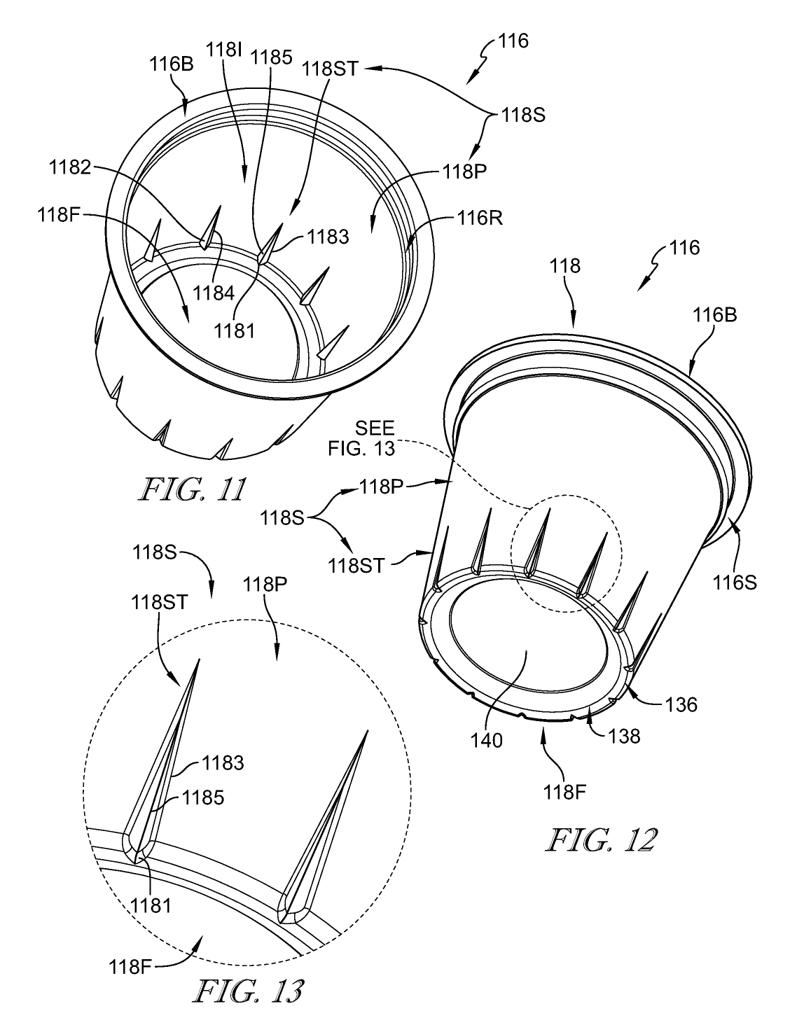

The support legs 1183 of adjacent stiffener panels 1182, 1184 converge toward one another as they extend up side wall 118S from floor 118F as shown in FIGS. 12 and 13. The base legs 1181 of adjacent stiffener panels 1182, 1184 converge toward one another as they extend along floor 118F from side wall 118S. Each side-wall stiffener 118ST is wider adjacent floor 118F and narrows as side-wall stiffener 118ST extends upward along side wall 118S.

In the illustrative embodiment, legs 1181, 1183, 1185 are substantially straight as suggested in FIG. 13. In some embodiments, the legs 1181, 1183, 1183 assume different shapes. For example, one embodiment of a tie leg may be curvilinear or arcuate in shape. In another example, one embodiment of a support leg may be curvilinear or arcuate in shape. Similarly, in some embodiments, a base leg may be curvilinear or arcuate in shape.

Side-wall stiffeners 1185T are circumferentially spaced apart from one another with a portion of frustoconical panel 118P positioned between adjacent side-wall stiffeners 1185T as shown in FIG. 5. In the illustrative embodiment, side-wall stiffeners 1185T extend partially up side wall 118S from floor 118F and terminate before reaching stacking shoulder 116S. Each side-wall stiffener 118ST terminates at an apex where support leg 1183 and tie leg 1185 meet along frustoconical panel 118P. In some embodiments, side-wall stiffeners 1185T extend approximately ⅓ of a distance between floor 118F and brim 116B. Floor 118F is substantially circular and notches are formed in a perimeter of floor 118F when side-wall stiffeners 1185T are formed as suggested in FIGS. 12 and 13. Side-wall stiffeners 1185T are inset radially relative to frustoconical panel 118P such that frustoconical panel 118P defines an outer diameter of bowl 118.

Floor stiffener 138 includes a first curved portion 138A, a second curved portion 138B, and a straight portion 138C as shown in FIGS. 8 and 10. First curved portion 138A has a convex shape arranged to extend upwardly toward central axis 118A with a radius of curvature outside interior region 1181. Second curved portion 138B has a concave shape arranged to extend downwardly away from central axis 118A with a radius of curvature inside interior region 1181. First curved portion 138A is coupled to floor mount 136 and arranged to extend toward central axis 118A. Straight portion 138C is coupled to floor disk 140 and arranged to extend from floor disk 140 toward side wall 118S and ground G underlying cup 116. Second curved portion 138B is arranged to extend between and interconnect first curved portion 138A and straight portion 138C. Second curved portion 138B engages ground underlying cup 116 while both first curved portion 138A and straight portion 138C are spaced apart from ground. Straight portion 138C is arranged to lie at angle 45 relative to ground G as shown in FIG. 8. Angle 45 is about 45 degrees, but any other suitable angle may be used.

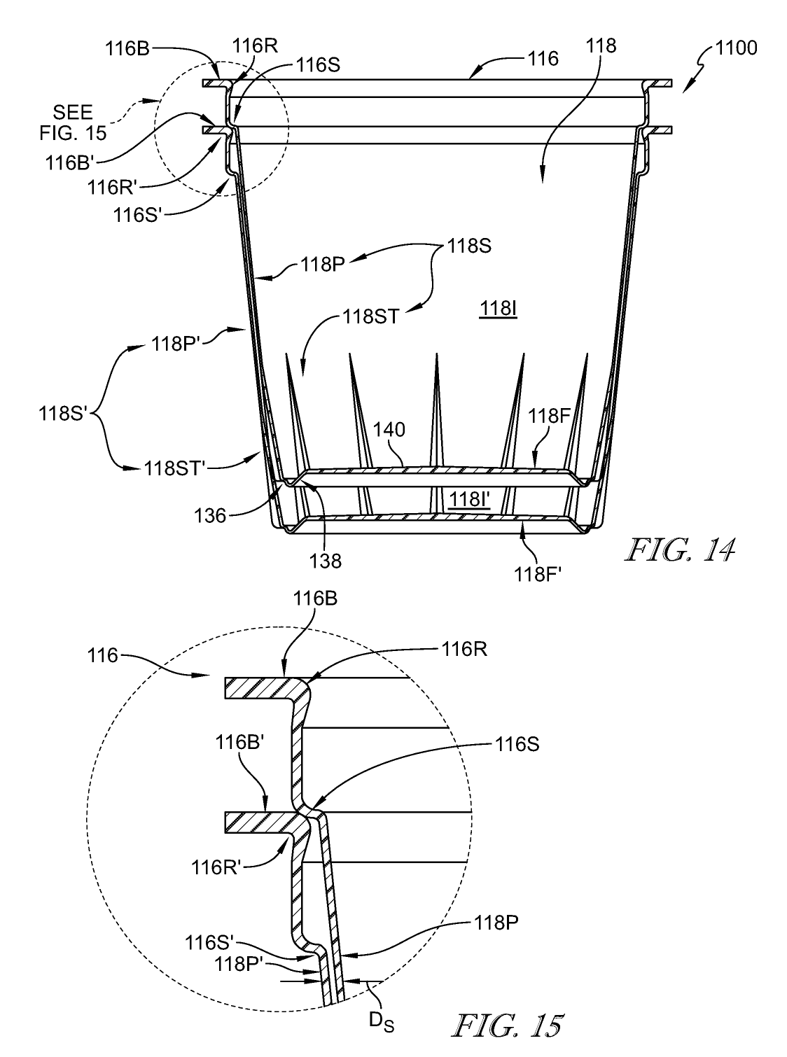

Cup 116 is formed to include stacking shoulder 116S which is arranged to extend radially outwardly from an upper portion of bowl 118 away from interior region 1181 as shown in FIGS. 14 and 15. In the illustrative embodiment, stacking shoulder 116S is annular and configured to engage a shoulder-support rim 116R defined by brim 116B. When stacking shoulder 116S of cup 116 engage the shoulder-support rim 116R′ of an underlying cup 116′, then a minimum separation distance D_{S} is maintained between stacked cups 116, 116′ so as to avoid unwanted wedging of one cup in another underlying neighboring cup.

Cup 116 also includes stacking shoulder 116S coupled to an upper portion of side wall 118S of bowl 118 and brim 116B coupled to an upper region of stacking shoulder 116S as shown, for example, in FIGS. 3 and 14-15. Brim 116B is configured to provide the uninterrupted border surrounding the top opening into interior region 1181 and define shoulder-support rim 116R. Stacking shoulder 116S cooperates with shoulder-support rim 216R′ included in neighboring cup 216′ in stack 1100 of cups 216, 216′ to maintain a minimum separation distance D_{S} between stacked cups 116, 116′ so that cups included in stack 1100 of cups that has been shipped to a brewing package assembly factory can be separated easily at that factory to facilitate manufacture and assembly of beverage brewing package 110.

Cup 116 and its bowl 118 are made using a thermoforming process in accordance with the illustrative embodiments of the present disclosure to facilitate positive formation of side-wall stiffeners 118ST, floor stiffener 138, stacking shoulder 116S, and brim 118B, for example. In the illustrative embodiment, portions of frustoconical panel 118P of bowl 118 are also thinner than the other components of cup 116, as suggested in FIGS. 7 and 14-15. The thinner material has less rigidity than the other portions of cup 116 and side-wall stiffeners 118ST and floor stiffener 138 are configured to stiffen side wall 118S against radially inward forces acting on cup 116 during exposure of cup 116 to hot pressurized water during brewing and against vertically acting compressive forces acting on cup 116 during puncture of cup 116 by cannula 21, 22 prior to brewing.

A cup for use in a beverage brewing package comprises a floor and a side wall. The side wall is coupled to the floor and arranged to extend upwardly from the floor. The side wall is arranged to extend around a central axis that is generally perpendicular to the floor. The floor and the side wall cooperate together to define an interior region formed in the cup.

The side wall is formed to include a series of side-wall stiffeners arranged to extend radially inwardly toward the central axis and into the interior region of the cup and lie in spaced-apart circumferential relation to one another around the side wall. The side-wall stiffeners are configured to provide stiffening means for reinforcing the side wall against radially inward forces exerted on the side wall so that the cup can substantially maintain its shape when handled by a user, during assembly of the beverage brewing package, during puncture of the brewing package by cannula prior to brewing, and during exposure of the brewing package to hot, high pressure water during brewing. Each side-wall stiffener includes a pair of converging stiffener panels. Together, the converging stiffener panels may, for example, cooperate to provide the means for reinforcing.

The floor includes a floor mount, a floor disc, and a floor stiffener. The floor mount is coupled to the side wall and the series of side-wall stiffeners and arranged to extend away from the side wall and the series of side-wall stiffeners toward the central axis. The floor disc is located in radial spaced-apart relation to the side wall, the side-wall stiffeners, and the floor mount. The floor stiffener is arranged to extend between and interconnect the floor mount and the floor disc and is configured to provide means for minimizing deformation of the floor disc during puncture of cup by the outlet cannula prior to brewing. The floor stiffener includes a first curved portion, a second curved portion, and a straight portion. Together, these portions may, for example, cooperate to provide the means for minimizing deformation.

A beverage brewing package 10 in accordance with the present disclosure is shown in FIG. 16. Beverage brewing package 10 is configured to store coffee grinds 12 in a filter bag 14 retained in a cup 16 as suggested in FIG. 17. A consumer can brew coffee 11 by placing beverage brewing package 10 in a coffee maker 20 and exposing coffee grinds 12 stored in filter bag 14 to pressurized hot water discharged from hot water source 19 as suggested in FIG. 19. Beverage brewing package 10 can also be used to brew tea by storing tea grinds in filter bag 14.

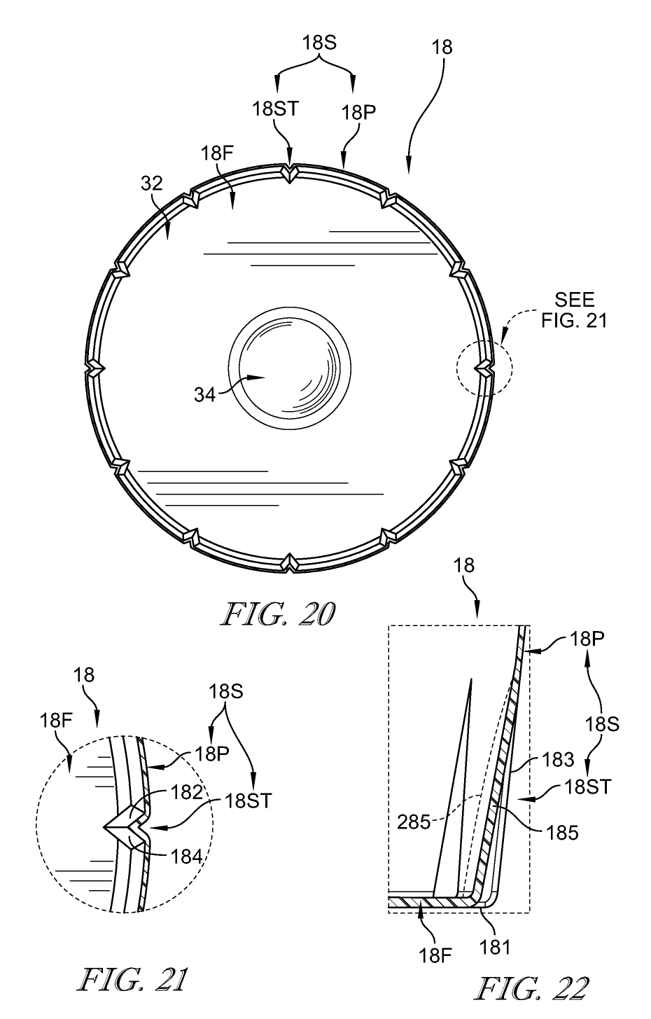

Cup 16 includes a bowl 18 having a floor 18F and a side wall 18S extending from floor 18F as shown, for example, in FIGS. 20-30. Side wall 18S includes a frustoconical panel 18P extending from floor 18F to define an interior region 181 of bowl 18 and a series of side-wall stiffeners 185T extending into interior region 181. Side-wall stiffeners 185T are coupled between floor 18F and frustoconical panel 18P to provide additional stiffness to side wall 18S than that provided by frustoconical panel 18P alone.

Cup 16 also includes a stacking shoulder 16S coupled to an upper portion of side wall 18S of bowl 18 and a brim 16B coupled to an upper region of stacking shoulder 16S as shown, for example, in FIGS. 18 and 31-32. Brim 16B is configured to provide an uninterrupted border surrounding a top opening into interior region 181 and defines a shoulder-support rim 16R. Stacking shoulder 16S cooperates with shoulder-support rim 16R′ included in a neighboring cup 16′ in a stack 100 of cups 16, 16′ to maintain a minimum separation distance D_{S} between stacked cups 16, 16′ so that cups included in a stack 100 of cups that have been shipped to a brewing package assembly factory may be separated easily at that factory to facilitate manufacture and assembly of beverage brewing package 10.

Cup 16 and its bowl 18 are made using a thermoforming process in accordance with the illustrative embodiments of the present disclosure to facilitate positive formation of side-wall stiffeners 18ST, stacking shoulder 16S, and brim 18B, for example. Cup 16 is formed from a thermoplastic material, such as polypropylene for example. In one example, the polypropylene is a polypropylene homopolymer. In another example, the polypropylene is a high crystalline polypropylene homopolymer. In another example, the polypropylene is INSPIRE 6025N available from BRASKEM.

Polypropylene may have a relatively low rigidity. In the illustrative embodiment, portions of frustoconical panel 18P of bowl 18 are also thinner than the other components of cup 16, as suggested in FIGS. 22 and 31-32. The thinner material has less rigidity than the other portions of cup 16 and side-wall stiffeners 18ST are configured to stiffen cup 16 against radially inward forces acting on cup 16 during exposure of cup 16 to hot pressurized water during brewing and against vertically acting compressive forces acting on cup 16 during puncture of cup 16 by cannula 21, 22 prior to brewing.

Beverage brewing package 10 includes a grinds carrier 15 comprising a bag-supporting panel 17 coupled to brim 16B of cup 16 and filter bag 14 as shown in FIGS. 16 and 17. Filter bag 14 mates with the underside of bag-supporting panel 17 to support filter bag 14 above floor 18F of bowl 18. Bag-supporting panel 17 is made of a metallic foil or a plastics film in illustrative embodiments of the present disclosure. Filter bag 14 is made of a water-permeable filter material and is configured to hold coffee, tea, or similar brewable particulates.

A diagrammatic view of a beverage brewing system such as a coffee maker 20 is provided in FIG. 19. Cup 16 of beverage brewing package 10 is placed on a cup support 13 included in coffee maker 20. Pressurized hot water 19 is admitted into filter bag 14 through an inlet cannula 21 that is arranged to pierce a portion of bag-supporting panel 17 located over bowl 18. Brewed coffee 11 is discharged from cup 16 through an outlet cannula 22 arranged to pierce floor 18F located below filter bag 14. Brewed coffee 11 is produced by exposing pressurized hot water 19 to coffee grinds 12 carried in filter bag 14. Such brewed coffee 11 flows into interior region 181 of bowl 18 and then exits beverage brewing package 10 through outlet cannula 22 as suggested in FIG. 19.

Side wall 18S of bowl 18 has a frustoconical shape as suggested in FIGS. 17, 18, 22, and 24 with a narrow end alongside floor 18F and a relatively wider end alongside brim 16B. Side wall 18S is arranged to extend upwardly from a perimeter edge of floor 18F toward stacking shoulder 16S and brim 16B. Side wall 18S cooperates with floor 18F to form interior region 181 of bowl 18 as suggested in FIG. 18.

Side wall 18S includes a generally frustoconical panel 18P extending from floor 18F to stacking shoulder 16S and a series of circumferentially spaced, radially inwardly extending side-wall stiffeners 185T as shown in FIGS. 20-30. Side-wall stiffeners 185T are configured to resist radially inward forces placed on side wall 18S by a user handling beverage brewing package 10 or during assembly of beverage brewing package 10. In some instances, side-wall stiffeners 185T are configured to resist radially inward buckling due to force placed on the top and/or bottom during brewing. In some embodiments, more or less side-wall stiffeners 185T are used to increase or decrease the stiffness of side wall 18S, respectively.

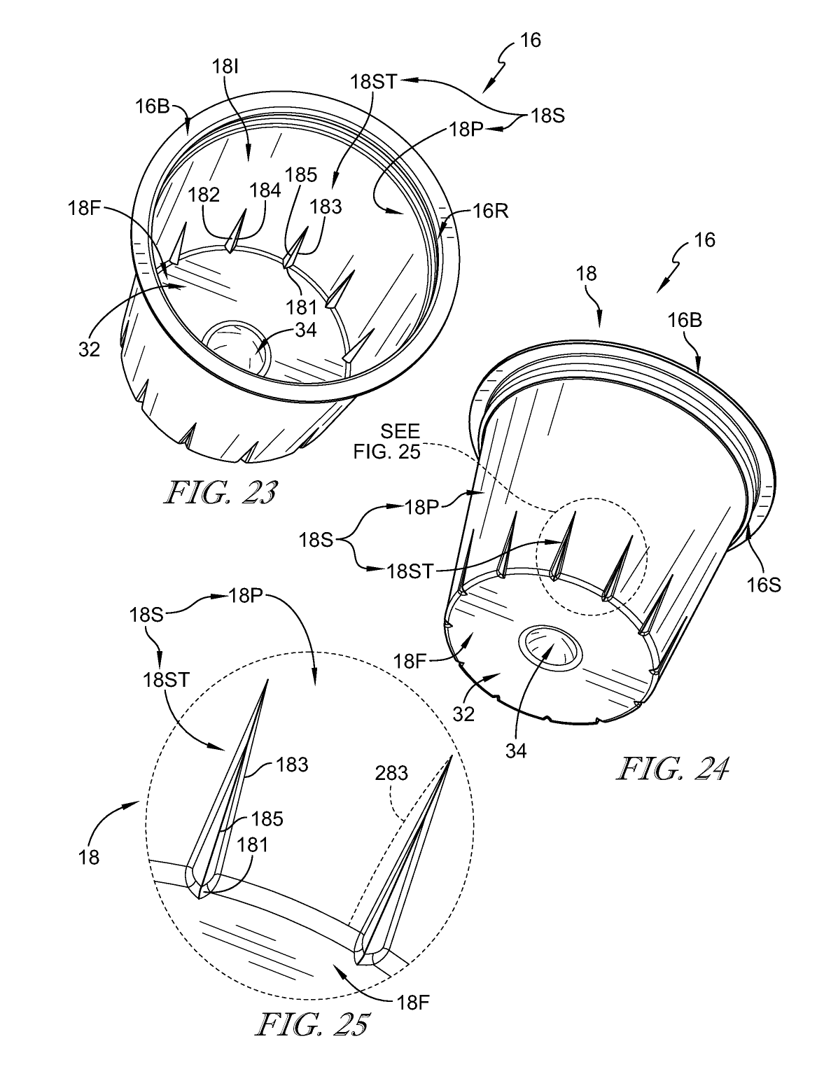

Each side-wall stiffener 185T includes a pair of converging stiffener panels 182, 184 coupled between floor 18F and frustoconical panel 18P. Each stiffener panel 182, 184 is defined by a base leg 181 extending along floor 18F, a support leg 183 extending upward from floor 18F along frustoconical panel 18P, and a tie leg 185 extending between distal ends of base leg 181 and support leg 183. Each stiffener panel 182, 184 is substantially triangular in shape and the tie legs 185 of adjacent stiffener panels 182, 184 are coupled to one another as suggested in FIG. 23.

Support legs 183 of adjacent stiffener panels 182, 184 converge toward one another as they extend up side wall 18S from floor 18F as shown in FIGS. 24 and 25. The base legs 181 of adjacent stiffener panels 182, 184 converge toward one another as they extend along floor 18F from side wall 18S. Each side-wall stiffener 18ST is wider adjacent floor 18F and narrows as side-wall stiffener 18ST extends upward along side wall 18S.

In the illustrative embodiment, legs 181, 183, 185 are substantially straight as suggested in FIG. 23. In some embodiments, the legs 181, 183, 183 assume different shapes. For example, one embodiment of a tie leg may be curvilinear or arcuate in shape. In another example, one embodiment of a support leg may be curvilinear or arcuate in shape. Similarly, in some embodiments, a base leg may be curvilinear or arcuate in shape.

Side-wall stiffeners 185T are circumferentially spaced apart from one another with a portion of frustoconical panel 18P positioned between adjacent side-wall stiffeners 185T as shown in FIG. 24. In the illustrative embodiment, side-wall stiffeners 185T extend partially up side wall 18S from floor 18F and terminate before reaching stacking shoulder 16S. Each side-wall stiffener 185T terminates at an apex where support leg 183 and tie leg 185 meet along frustoconical panel 18P. In some embodiments, side-wall stiffeners 185T extend approximately ⅓ of a distance between floor 18F and brim 16B. Floor 18F is substantially circular and notches are formed in a perimeter of floor 18F when side-wall stiffeners 185T are formed as suggested in FIGS. 24 and 25. Side-wall stiffeners 185T are inset radially relative to frustoconical panel 18P such that frustoconical panel 18P defines an outer diameter of bowl 18.

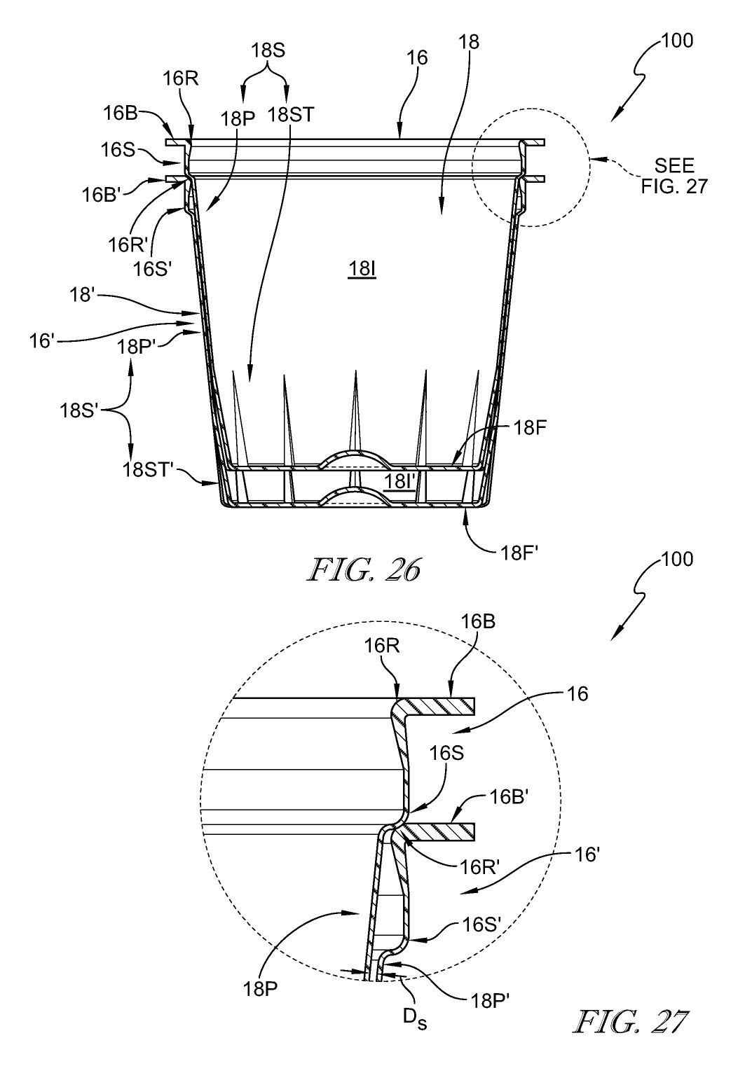

Cup 16 is formed to include stacking shoulder 16S which is arranged to extend radially outwardly from an upper portion of bowl 18 away from interior region 181 as shown in FIGS. 26 and 27. In the illustrative embodiment, stacking shoulder 16S is annular and configured to engage a shoulder-support rim 16R defined by brim 16B. When stacking shoulder 16S of cup 16 engage the shoulder-support rim 16R′ of an underlying cup 16′, then a minimum separation distance D_{S} is maintained between stacked cups 16, 16′ so as to avoid unwanted wedging of one cup in another underlying neighboring cup.

Floor 18F includes, for example, a floor dome and a floor dome 34 and a floor disc 32 as shown in FIG. 24. Floor disc 32 is arranged to extend between and interconnect floor dome 34 and side wall 18S and 18ST. Central axis 18A is arranged to extend through floor dome 34 as suggested in FIG. 17. In one example, outlet cannula 22 pierces floor dome 34. In another example, outlet cannula 22 pierces floor disc 32.

Cup 16 also includes stacking shoulder 16S coupled to an upper portion of side wall 18S of bowl 18 and brim 16B coupled to an upper region of stacking shoulder 16S as shown, for example, in FIGS. 18 and 26-27. Brim 16B is configured to provide the uninterrupted border surrounding the top opening into interior region 181 and define shoulder-support rim 16R. Stacking shoulder 16S cooperates with shoulder-support rim 16R′ included in neighboring cup 16′ in stack 100 of cups 16, 16′ to provide means for maintaining a minimum separation distance D_{S} between stacked cups 16, 16′ so that cups included in stack 100 of cups that has been shipped to a brewing package assembly factory can be separated easily at that factory to facilitate manufacture and assembly of beverage brewing package 10.

Cup 16 and its bowl 18 are made using a thermoforming process in accordance with the illustrative embodiments of the present disclosure to facilitate positive formation of side-wall stiffeners 185T, stacking shoulder 16S, and brim 18B, for example. In the illustrative embodiment, portions of frustoconical panel 18P of bowl 18 are also thinner than the other components of cup 16, as suggested in FIGS. 22 and 26-27. The thinner material has less rigidity than the other portions of cup 16 and side-wall stiffeners 185T are configured to provide means for stiffening side wall 18S against radially inward forces acting on cup 16 during exposure of cup 16 to hot pressurized water during brewing and against vertically acting compressive forces acting on cup 16 during puncture of cup 16 by cannula 21, 22 prior to brewing.

1. A cup for use in a beverage brewing package comprising
a floor and
a side wall coupled to the floor and arranged to extend upwardly from the floor and around a central axis that is generally perpendicular to the floor, the floor and the side wall cooperating together to define an interior region formed in the cup,
wherein the side wall is formed to include a series of side-wall stiffeners arranged to extend radially inwardly toward the central axis and into the interior region of the cup and lie in spaced-apart circumferential relation to one another around the side wall and the series of side-wall stiffeners are configured to provide reinforcement to the side wall against radially inward forces exerted on the side wall so that the cup can substantially maintain its shape when handled by a user, during assembly of the beverage brewing package, during puncture of the beverage brewing package by cannula prior to brewing, and during exposure of the beverage brewing package to hot, high pressure water during brewing.

2. The cup of claim 1, wherein the floor and the side wall are formed from polypropylene.

3. The cup of claim 2, wherein the series of side-wall stiffeners each include a pair of converging stiffener panels which extend radially inward toward the central axis from the side wall and couple to the floor.

4. The cup of claim 3, wherein each stiffener panel is defined by a base leg extending along the floor, a support leg extending along the side wall from the base leg, and a tie leg extending between distal ends of the base leg and the support leg.

5. The cup of claim 2, wherein the side wall further includes a frustoconical panel arranged to extend from the floor around the central axis and wherein the series of side-wall stiffeners are arranged to extend between and interconnect the frustoconical panel and the floor.

6. The cup of claim 5, wherein the floor, the frustoconical panel, and the series of side-wall stiffeners cooperate to form a monolithic element.

7. The cup of claim 6, wherein the frustoconical panel has a thickness less than other portions of the cup.

8. The cup of claim 2, further comprising a stacking shoulder coupled to an upper portion of the side wall and extending radially outward from the side wall and a brim coupled to the stacking shoulder to locate the stacking shoulder between the brim and the side wall.

9. The cup of claim 8, wherein the brim includes a shoulder-support rim configured to maintain a minimum separation distance between side walls of cups in a stack of cups to prevent wedging between the cups when a stacking shoulder of an upper cup engages a shoulder-support rim of a lower cup.

10. The cup of claim 1, wherein the floor includes a floor mount coupled to the side wall and the series of side-wall stiffeners and arranged to extend away from the side wall and the series of side-wall stiffeners toward the central axis, a floor disc located in radial spaced-apart relation to the side wall, the series of side-wall stiffeners, and the floor mount, and a floor stiffener arranged to extend between and interconnect the floor mount and the floor disc, the floor stiffener is configured is configured to minimize deformation of the floor disc during puncture of the cup by an outlet cannula prior to brewing.

11. The cup of claim 10, wherein the floor mount and and the floor disc are spaced apart from ground underlying the cup.

12. The cup of claim 10, wherein the floor disc is spaced apart from ground underlying the cup and the floor stiffener includes a first portion coupled to the floor mount and arranged to extend toward the central axis away from the floor mount, a second portion coupled to the first portion and arranged to extend from the first portion toward the central axis, and a third portion coupled to the second portion and arranged to extend between and interconnect the second portion and the floor disc.

13. The cup of claim 12, wherein the first portion is arranged to extend downwardly toward ground and have a curved shape with a radius of curvature located outside the interior region and the second portion is arranged to extend upwardly away from ground toward the floor disc and have a curved shape with a radius of curvature located inside the interior region.

14. The cup of claim 12, wherein the first portion is arranged to extend downwardly toward ground and have a curved shape with a radius of curvature located outside the interior region, the second portion is arranged to extend upwardly away from ground toward the floor disc and have a curved shape with a radius of curvature located inside the interior region, and the third portion is straight and defines an included angle between the third portion and ground of about 45 degrees.

15. A cup for use in a beverage brewing package comprising
a floor and
a side wall coupled to the floor and arranged to extend upwardly from the floor and around a central axis that is generally perpendicular to the floor, the floor and the side wall cooperating together to define an interior region formed in the cup,
wherein the side wall is formed to include a series of side-wall stiffeners arranged to extend radially inwardly toward the central axis and into the interior region of the cup and lie in spaced-apart circumferential relation to one another around the side wall and the series of side-wall stiffeners are configured to provide stiffening means for reinforcing the side wall against radially inward forces exerted on the side wall so that the cup can substantially maintain its shape when handled by a user, during assembly of the beverage brewing package, during puncture of the beverage brewing package by cannula prior to brewing, and during exposure of the beverage brewing package to hot, high pressure water during brewing.

16. The cup of claim 15, wherein the floor and the side wall are formed from polypropylene.

17. The cup of claim 16, wherein the side wall further includes a frustoconical panel arranged to extend from the floor around the central axis and wherein the series of side-wall stiffeners are arranged to extend between and interconnect the frustoconical panel and the floor.

18. The cup of claim 17, wherein the floor, the frustoconical panel, and the series of side-wall stiffeners cooperate to form a monolithic element and the frustoconical panel has a thickness less than other portions of the cup.

19. The cup of claim 18, wherein the series of side-wall stiffeners each include a pair of converging stiffener panels which extend radially inward toward the central axis from the side wall and couple to the floor and each stiffener panel is defined by a base leg extending along the floor, a support leg extending along the side wall from the base leg, and a tie leg extending between distal ends of the base leg and the support leg.

20. The cup of claim 15, wherein the floor includes a floor mount coupled to the side wall and the series of side-wall stiffeners and arranged to extend away from the side wall and the series of side-wall stiffeners toward the central axis, a floor disc located in radial spaced-apart relation to the side wall, the series of side-wall stiffeners, and the floor mount, and a floor stiffener arranged to extend between and interconnect the floor mount and the floor disc and configured to provide means for minimizing deformation of the floor disc during puncture of the cup by an outlet cannula prior to brewing.
